(19) United States
(12) Patent Application Publication
(10) Pub. No.: US 2006/0272388 A1
(43) Pub. Date: Dec. 7, 2006

(54) Apparatus and method for testing endurance of optical disc

(76) Inventors: Jin Hong Kim, Yongin-si (KR); Hun Seo, Yongin-si (KR); Chang Ho Lee, Goyang-si (KR); Tae Hee Jeong, Seongnam-si (KR); Keum Cheol Kwak, Seoul (KR); Seoung Won Lee, Daejeon (KR)

Correspondence Address: HARNESS, DICKEY & PIERCE, P.L.C., P.O. BOX 8910, RESTON, VA, 20195, US

(21) Appl. No.: 11/502,442

(22) Filed: Aug. 11, 2006

Related U.S. Application Data
(63) Continuation of application No. 10/801,041, filed on Mar. 16, 2004.

(30) Foreign Application Priority Data
Mar. 17, 2003 (KR) 10-2003-16514

(51) Int. Cl. G01N 3/56

(52) U.S. Cl. 73/7

(57) ABSTRACT

In the data structure, a data area of the recording medium stores a transport stream of at least video data. The transport stream is divided into transport packets, and each of the transport packets is associated with one of the multiple reproduction paths. Also, the transport packets of each reproduction path is stored in separate physical domains of the data area from one another.

### DOMESTIC PRIORITY INFORMATION

This is a continuation of application Ser. No. 10/801,041 filed Mar. 16, 2004; the entire contents of which is hereby incorporated by reference.

### FOREIGN PRIORITY INFORMATION

This application claims the benefit of Korean Application No. P2003-016514, filed on Mar. 17, 2003, which is hereby incorporated by reference as if fully set forth herein.

### BACKGROUND OF THE INVENTION

1. Field of the Invention

The present invention relates to an apparatus and method for testing an optical disc, and more particularly, to an apparatus and method for testing an endurance of a surface of an optical disc. Although the present invention is suitable for a wide scope of applications, it is particularly suitable for providing a standardized criterion for testing the endurance of the optical disc, thereby enhancing the reliability of the endurance test.

2. Discussion of the Related Art

Current types of recording media include magnetic tapes, optical discs, such as laser discs and compact discs, and digital video discs (DVD's) capable of storing large capacity information. Recently, standardization of Blu-ray Disc (BD), which is a new high-density optical disc capable of recording large capacity high-quality video and audio data, is in progress. Among such recording media, unlike most conventional magnetic tape, the optical disc stores data according to a digital recording method and is extremely small in volume and lightweight, thereby facilitating storage and portability.

However, the optical disc has the disadvantages of scratches formed on the surface of the disc, deformity, and foreign materials formed during the manufacturing process, which strikingly deteriorate the functions of the optical disc. Thus, a wide range of tests are required to resolve and overcome such problems. For example, the functions and the endurance of the optical disc are tested by measuring a high frequency signal, a jitter, a focusing error signal, a tracking error signal, and so on, based on signals represented from the optical disc.

The endurance test is carried out to test the endurance of a protective layer formed to prevent physical damage on the surface of the optical disc. In recent technology, the most widely used types of endurance tests are a pencil hardness test, and a taber abrasion test.

In the pencil hardness test, a plurality of pencils each having a different hardness are contacted on the surface of the optical disc, so as to scratch the surface of the disc. Herein, the endurance of the optical disc is tested based upon the hardness of the pencil that produces scratches on the surface of the optical disc. On the other hand, in the taber abrasion test, an abrasion wheel is used to wear away the surface of the optical disc, and the endurance of the optical disc is tested based upon the abrasive wear thereof.

However, in the pencil hardness test, the tester manually contacts each pencil on the surface of the optical disc, and, therefore, the tester is unable to apply a uniform pressure on the pencils. Eventually, the shape and the location of the scratches cannot be uniform. Also, in the taber abrasion test, while using the abrasion wheel, the abrasive wear on the surface of the optical disc is very different from the scratches on the optical disc. Therefore, testing the endurance of the optical disc based on the abrasive wear caused by the abrasion wheel is not appropriate. Moreover, since the criterion of whether the optical disc is normal or deficient is not standardized in both of the testing methods, the test results for the endurance of the optical disc are not highly reliable.

### SUMMARY OF THE INVENTION

The present invention relates to an apparatus and method for testing endurance of an optical disc.

In one embodiment, the apparatus for testing an endurance of an optical disc includes a rotation plate configured to rotate an optical disc. A scratching unit is configured to produce a scratch on a surface of the optical disc being rotated by the rotating plate, and a frame is configured to cause the scratching unit to apply pressure to the optical disc.

In one embodiment, the scratching unit includes a scratcher configured to produce a scratch on the surface of the optical disc, and a holder configured to hold the scratcher. For example, the scratcher may formed of steel wool.

Also, in one embodiment, the frame is configured to cause the scratching unit to apply pressure in a range of 50 to 5000 gf/cm2 to the optical disc.

In an embodiment, a method for testing an endurance of an optical disc, includes disposing the optical disc on a rotation plate. The optical disc is rotated along with the rotation plate, and pressure is applied to the optical disc using a scratching unit while the optical disc rotates for a number of rotation turns. This produces a scratch on a surface of the optical disc. The endurance of the optical disc is determined based on the scratch produced on the surface of the optical disc.

In one embodiment, the applying step applies pressure for 5 rotation turns or less of the optical disc.

In another embodiment, the applying step applies pressure based on a number of rotation turns of the optical disc.

In a further embodiment, the applying step applies pressure in a range of 500 to 1500 gf/cm2.

Also, in one embodiment, the optical disc is determined to be deficient if a depth of the scratch is equal to or more than 2 micrometers (μm), and is determined to be normal if the depth of the scratch is less than 2 micrometers (μm).

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings;

FIG. 1 illustrates an apparatus for testing an endurance of a surface of an optical disc according to an embodiment of the present invention;

FIG. 2 illustrates a flow chart of a method for testing the endurance of the surface of the optical disc according to an embodiment of the present invention;

FIG. 3 illustrates a scratch pattern formed on the optical disc by using a micro-scratch tester;

FIG. 4 illustrates an occurrence of a servo error in accordance with a scratch depth of a bare disc and a hard-coated disc;

FIG. 5 illustrates a graph showing the test results of the scratch depths based upon the pressure applied to the optical disc; and

FIG. 6 illustrates a graph showing the jitter values based upon the number of rotation turns of the optical disc.

### DETAILED DESCRIPTION OF THE INVENTION

Reference will now be made in detail to the example embodiments of the present invention, which are illustrated in the accompanying drawings. Wherever possible, the same reference numbers will be used throughout the drawings to refer to the same or like parts.

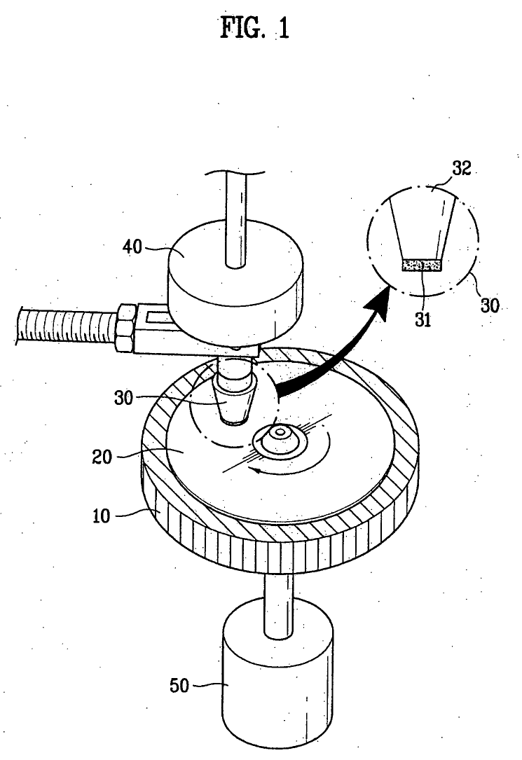

FIG. 1 illustrates an apparatus for testing an endurance of a surface of an optical disc according to an embodiment of the present invention. Referring to FIG. 1, the apparatus for testing the endurance of the optical disc according to the present invention includes a rotation plate 10, a scratching unit 30, and a frame 40.

The rotation plate 10 receives a rotation force from a motor 50 formed below the rotation plate 10 so as to rotate an optical disc 20 at a constant speed. The scratching unit 30 is fixed to the frame 40 and produces scratches on the surface of the optical disc 20. The frame 40 presses the scratching unit 30 with a constant pressure, so as to generate friction between the rotating optical disc 20 and the scratching unit 30. The frame 40 supplies the scratching unit 30 with either a constant pressure generated from its own load or a constant vapor pressure.

The scratching unit 30 includes a scratcher 31 producing scratches on the surface of the optical disc, and a holder 32 holding the scratcher 31. Herein, the scratcher 31 is formed of steel wool, and the types of steel wool include #0, #00, #000, and #0000.

A method for testing the endurance of the surface of the optical disc according to an embodiment of the present invention will now be described as follows.

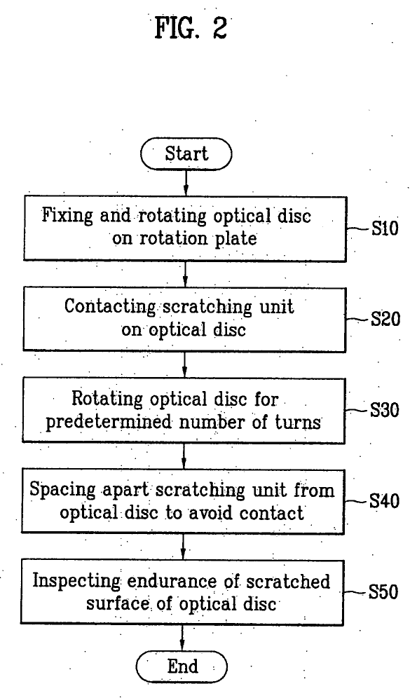

FIG. 2 illustrates a flow chart of a method for testing the endurance of the surface of the optical disc according to the present invention. Referring to FIG. 2, the optical disc 20 is fixed on the rotation plate 10, and then the motor 50 is operated so as to rotate the optical disc 20 along with the rotation plate 10 (S10). After placing the scratching unit 30 over the rotating optical disc 20, the scratching unit 30 is moved downwards to allow the scratcher 31 to come in contact with the surface of the optical disc 20 (S20). Subsequently, the frame 40 supplies the scratching unit 30 with a constant pressure, thereby allowing the scratching unit 30 to contact the surface of the rotating optical disc 20 with a constant friction.

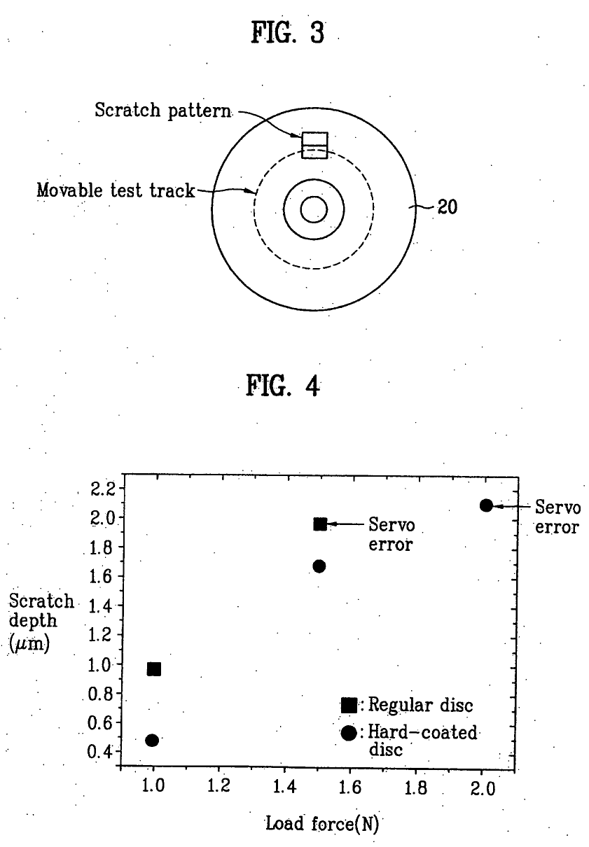

FIG. 3 illustrates a scratch pattern formed on the surface of the optical disc 20 by using a micro-scratch tester. The scratch pattern is used to determine and decide the optimum condition for the endurance test. Namely, the depth of the scratch, the pressure of the frame, which is the pressure applied to the optical disc 20, the type of scratcher 31, and the number of rotation turns of the optical disc 20 are selected for the test.

FIG. 4 illustrates an occurrence of a servo error in accordance with a scratch depth based on the pressure applied to the optical disc 20, and more specifically, shows the comparison between a bare disc having no protective layer and a hard-coated disc. When the depth of the scratch is at least 2 micrometers (μm), a servo error occurs in both discs. Accordingly, when testing the endurance of the optical disc, it will be appropriate to set the standard scratch depth as 2 micrometers (μm) for determining whether the optical disc 20 is deficient or normal.

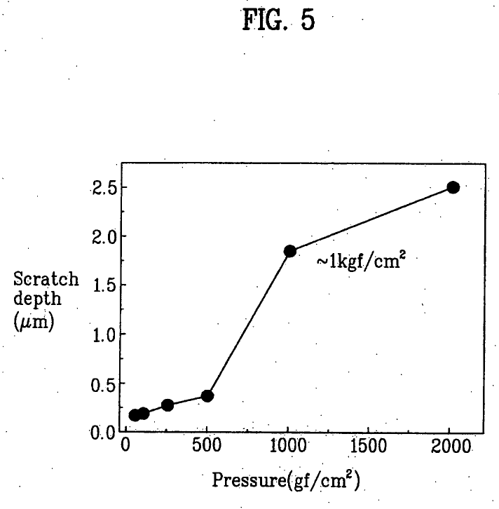

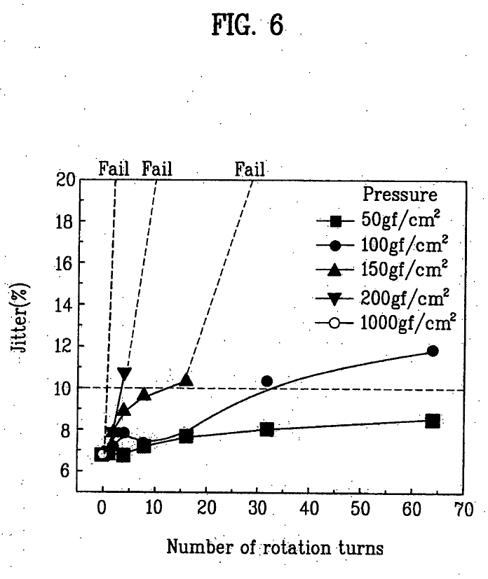

FIG. 5 illustrates a graph showing the scratch depths caused by a vertical pressure applied from the frame 40 to the optical disc 20 via the scratching unit 30. The graph shows the scratch depth formed under the condition where a #000 steel wool is used as the scratcher 31 and the optical disc 20 is rotated for only one turn. Referring to FIG. 5, in order to produce a scratch having a depth of approximately 2 micrometers (μm), while the optical disc 20 rotates for one turn, the pressure the frame 40 causes the scratching unit 30 to apply to the optical disc 20 should be 1000 gf/cm². Moreover, in order to produce a scratch having a depth of approximately 2 micrometers (μm), while the optical disc 20 rotates for two turns, the pressure the frame 40 causes the scratching unit 30 to apply to the optical disc 20 should be equal to or less than 1000 gf/cm². Similarly, the pressure the frame 40 causes the scratching unit 30 to apply may be determined based on the type of scratcher 31 and the number of rotation turns of the optical disc 20. The pressure may be in the range of 50 to 5000 gf/cm², however, it may be preferable that the pressure is set at the range of 500 to 1500 gf/cm².

Also, the number of rotations of the optical disc 20, while the scratcher 31 contacts the surface of the optical disc 20, may be limited to a maximum of 5 rotation turns. The scratches that may occur during an actual usage of a user are caused by a plurality of casual scratches. Conversely, the scratch caused by the scratching unit 30 results from a plurality of rotation turns of the optical disc 20. And so, the two types of scratches described above are not be the same. Therefore, in order to produce scratches that are most similar to the scratches that may occur during everyday usage, the number of rotation turns of the optical disc 20 may be limited to 5 turns or less.

As described above, when the pressure the frame 40 causes the scratching unit 30 to apply, the type of scratcher 31, and the number of rotation turns of the optical disc 20 are determined and set, the optical disc 20 rotates in accordance with the determined conditions, in order to scratch the surface of the optical disc 20 (S30). Subsequently, the scratching unit 30 is spaced apart from the optical disc 20 (S40), and, the scratch is inspected so as to determine the endurance of the optical disc 20 (S50). When the depth of the scratch is equal to or more than 2 micrometers (μm), the optical disc 20 is determined to be deficient. Conversely, when the depth of the scratch is less than 2 micrometers (μm), the optical disc is determined to be normal.

FIG. 6 illustrates a graph showing the jitter values based upon the pressure applied to the optical disc 20 and the number of rotation turns of the optical disc 20. Referring to FIG. 6, the jitter value increases in proportion to the pressure of the frame 40 applied to the optical disc 20 and the number of rotation turns of the optical disc 20.

Apart from the endurance test of the optical disc 20, a symbol error rate (SER) or a bit error rate (BER), a focusing error signal, which is a servo error signal, and a tracking error signal are measured, so as to optionally test the functions of the optical disc.

As described above, in the apparatus and method for testing the endurance of the optical disc according to the present invention, a tester scratch for testing the endurance of the optical scratch may form similar scratches to the scratches that occur during everyday usage. Furthermore, a plurality of conditions required for testing the endurance of the optical disc may be standardized, thereby providing a test with a more enhanced and higher reliability.

It will be apparent to those skilled in the art that various modifications and variations can be made in the present invention without departing from the spirit or scope of the inventions. Thus, it is intended that the present invention covers the modifications and variations of this invention.

What is claimed:

1. An apparatus for testing an endurance of an optical disc, comprising:
a rotation plate configured to rotate an optical disc;
a scratching unit configured to produce a scratch on a surface of the optical disc being rotated by the rotation plate; and
a frame configured to cause the scratching unit to apply pressure to the optical disc while the optical disc rotates a number of turns so as to produce a scratch, for determining endurance of the optical disc, on the surface of the optical disc.

2. The apparatus according to claim 1, wherein the scratching unit includes a scratcher configured to produce a scratch on the surface of the optical disc, and a holder configured to hold the scratcher.

3. The apparatus according to claim 2, wherein the scratcher is formed of steel wool.

4. The apparatus according to claim 1, wherein the frame is configured to cause the scratching unit to apply pressure in a range of 50 to 5000 fg/cm² to the optical disc.

5. The apparatus according to claim 1, wherein the frame is weighted to cause the scratching unit to apply pressure to the optical disc.

6. The apparatus according to claim 1, further comprising:
a motor disposed below the rotation plate and configured to provide a rotation force to the rotation plate.

7. A recording medium having an entrance surface, which has sufficient resistance or not with respect to a scratch, the recording medium can be verified by a test to determine whether the surface of the recording medium has a sufficient resistance, wherein the test includes the steps of disposing the recording medium on a rotation plate, rotating the recording medium along with the rotation plate, applying predetermined pressure to the recording medium using a scratching unit to produce a scratch on the surface of the recording medium, and determining the endurance of the recording medium based on the scratch produced on the surface.
